(19) United States
(12) Patent Application Publication
(10) Pub. No.: US 2025/0115791 A1
(43) Pub. Date: Apr. 10, 2025

(54) ASYMMETRIC BONDING MEANS

(71) Applicant: Lohmann GmbH & Co. KG, Neuwied (DE)

(72) Inventors: Jan ELLER, Andernach (DE); Mark Pascal LANTERS, Urbar (DE)

(21) Appl. No.: 18/698,447

(22) PCT Filed: Oct. 7, 2021
(86) PCT No.: PCT/EP2021/077745

§ 371 Date: Apr. 4, 2024

(51) Int. Cl. C09J 7/35; B32B 7/12; C09J 7/10

(52) U.S. Cl. CPC C09J 7/35; B32B 7/12; C09J 7/10; B32B 2250/03; B32B 2255/26; B32B 2274/00; B32B 2405/00; C09J 2301/208

(57) ABSTRACT

The invention relates to an asymmetric bonding means for bonding two different components to be joined, with a first adhesive layer and a second adhesive layer arranged opposite to the first adhesive layer. In order to achieve a cheap and cost-effective bonding of components to be bonded that were difficult to bond so far, the first adhesive layer comprises at least one reactive adhesive and the second adhesive layer comprises at least one thermoplastic adhesive.

### CROSS-REFERENCE TO RELATED APPLICATIONS

The present application claims priority to PCT patent application PCT/EP2021/077745, “Asymmetrisches Klebemittel” (Asymmetric bonding means), filed Oct. 7, 2021, which is hereby incorporated by reference.

### FIELD OF TECHNOLOGY

The present technology relates to an asymmetric bonding means.

### BACKGROUND

It is known to use asymmetric bonding means in order to bond two different components to be bonded, these asymmetric bonding means comprise two adhesive layers opposite to each other which consist of different thermoplastic adhesives. However, these asymmetric bonding means are not suitable for any combination of components to be bonded. Known thermoplastic adhesives often struggle to provide a strong and lasting bond with textile components to be bonded.

It is an object of the present technology to provide a generic bonding means which achieves an easy and cost-effective bonding of components to be bonded that were difficult to bond so far. This object is achieved by the features of claims 1 and 10, while other embodiments and improvements of the present technology may be taken from the dependent claims.

### BRIEF SUMMARY

The present technology relates to an asymmetric bonding means for bonding two different components to be bonded, with a first adhesive layer and a second adhesive layer arranged opposite to the first adhesive layer.

### DESCRIPTION

It is proposed that the first adhesive layer comprises at least one reactive adhesive and the second adhesive layer comprises at least one thermoplastic adhesive. This way, a number of possible components to be bonded that can be bonded using the asymmetric bonding means can be increased. Advantageously, the combination of two different types of adhesives allows for a bonding of components to be bonded which exhibit different compatibilities with certain adhesive types due to their material properties and therefore cannot be bonded in a sufficient manner with two identical adhesive layers.

In particular, the components to be bonded may differ in a variety of material properties influencing a bonding of adhesive means on the components to be bonded. For example, the components to be bonded can differ in a chemical composition, a surface energy, a roughness, a hardness, a stretchability, a thermal expansion coefficient, a microscopic structure, a macroscopic structure, a microscopic surface shape and/or a macroscopic surface shape. Advantageously, the components to be bonded comprise at least two different materials. For example, the components to be bonded may comprise any combination of metals, glasses, plastics, elastomers, celluloses, textiles and/or coatings.

It is possible that the adhesive layers are embodied as full-surface adhesive layers. Alternatively, one or both of the adhesive layers may be embodied as partial-surface adhesive layers and in particular comprise at least one gap and/or recess. In particular, one or both of the adhesive layers may be embodied in the shape of any pattern, such as a net or a grate for example. Furthermore, it could be imagined that the adhesive layers consist of a multitude of separate adhesive elements, which may for example be embodied as rectangles, ovals, lines, meanders or amorphous shapes.

The adhesive layers may in particular be arranged by any method known to one of ordinary skill in the art. For example, the adhesive layers may be arranged using common coating methods such as curtain coating or blade coating. Alternatively, the adhesive layers may be arranged using common 2D or 3D printing methods, such as screen printing, 3D screen printing, inkjet printing and/or LAM printing.

The second adhesive layer being arranged opposite to the first adhesive layer is to be understood as the adhesive layers each having a main side facing towards the other adhesive layer and a further main side facing away from the other adhesive layer.

A “reactive” adhesive is to be understood as an adhesive comprising a non-cured state and a cured state and the adhesive being able to irreversibly transition from the non-cured state into the cured state. It is possible that the first adhesive layer is permanently tacky in the non-cured state, alternatively, the first adhesive layer may be tacky only under certain conditions in the non-cured state, such as directly after an initiation of a curing reaction. In particular, the first adhesive layer is devoid of tacky surfaces in the cured state. A speed of the curing reaction is, in particular, dependent on the type of reactive adhesive. It could be imagined that the curing reaction is slow enough to allow for an application of the asymmetric bonding means on the components to be bonded after an initiation of the curing reaction. Alternatively, the curing reaction could be fast and require an initiation of the curing reaction to take place after an application of the asymmetric bonding means on the components to be bonded. It could be imagined that the reactive adhesive is embodied as a multi-component adhesive, preferably, the reactive adhesive is embodied as a one-component adhesive.

A “thermoplastic” adhesive is to be understood as an adhesive with a melting point defining a transition between a liquid or highly viscous state and a solid state of the adhesive, regardless of a state of the adhesive. In particular, the thermoplastic adhesive is devoid of cured states in which the reversible transition is prevented. Preferably, the second adhesive layer is tacky in the liquid or highly viscous state of the thermoplastic adhesive. Especially preferably, the second adhesive layer is devoid of tacky surfaces in the solid state of the thermoplastic adhesive. In particular, the thermoplastic adhesive is configured to be in the liquid or highly viscous state before an application of the asymmetric bonding means on the components to be bonded and in the solid state after the application of the asymmetric bonding means on the components to be bonded. Preferably, the thermoplastic adhesive is partially, in particular at a surface of the second adhesive layer, in the liquid or highly viscous state before the application of the asymmetric bonding means on the components to be bonded. Alternatively, the thermoplastic adhesive may be in the solid state after the application of the asymmetric bonding means on the components to be bonded, in which case the application of the asymmetric bonding means on the components to be bonded is followed by an additional heating step in order to transition the thermoplastic adhesive to the liquid or highly viscous state for a short time.

The thermoplastic adhesive may, in particular, comprise any substance known to one of ordinary skill in the art of thermoplastic adhesives. For example, the thermoplastic adhesive may comprise at least one basic polymer, which may be a polyamide, polyethylene, polyalphaolefin, ethylene-vinyl acetate copolymer, copolyester elastomer, polyurethan elastomer, copolyamide elastomer, and/or vinylpyrrolidone/vinyl acetate copolymer. Furthermore, the thermoplastic adhesive could comprise at least one additive, which may be a resin, in particular rosin, terpene and/or hydrocarbon resins, a stabilizer, in particular amines, phenols, metal deactivators and/or light stabilizers, a wax, in particular synthetic waxes and/or natural waxes, a plasticizer, in particular phthalic acid esters, an extender, in particular chalk, barites, or titan dioxide and/or a nucleating agent.

In order to improve upon a bonding of the asymmetric adhesive means, in particular on metallic components to be bonded, it is proposed that the thermoplastic adhesive comprises at least one copolyester elastomer. It could be imagined that the thermoplastic adhesive comprises further substances, in particular further adhesives and/or additives. Preferably, the thermoplastic adhesive consists entirely of the copolyester elastomer. This way, the asymmetric bonding means can be used for bonding of metallic components to be bonded to non-metallic components to be bonded and can therefore be used in a variety of fields of application, such as for example metal working and the automobile industry.

The thermoplastic adhesive used could have any melting point, depending on the field of application. In order to improve upon a robustness, it is proposed that the melting point of the thermoplastic adhesive is at least 90° C., advantageously at least 100° C. and especially advantageously at least 110° C. This way, an inadvertent debonding of the components to be bonded can be prevented, in particular in applications in the automobile industry, where the components to be bonded may be exposed to high temperatures on a regular basis.

The reactive adhesive may, in particular, comprise any substances known to a person skilled in the art of reactive adhesives. For example, the reactive adhesive could be embodied as a polyaddition adhesive, a polycondensation adhesive or a polymerization adhesive. Furthermore, the reactive adhesive could comprise at least one amine, amide, carboxylic acid anhydride, mercaptan, epoxide resin, polyurethane, silicone, silane-modified polymer, phenol resin, cyan acry late, methyl methacry late, methacrylate, cumene hydroperoxide and/or saccharin. In particular, the reactive adhesive may comprise additives, which may be curing agents, in particular dicyanodiamide and/or isocyanate, fillers, in particular particles made of metal, glass, carbon and/or plastic, tackifiers and/or catalysts.

In order to improve upon a bonding of the asymmetric bonding means on textile components to be bonded, it is proposed that the reactive adhesive comprises at least one polyurethane. For example, the reactive adhesive may comprise an aliphatic polyurethane and/or an aromatic polyurethane. Preferably, the reactive adhesive comprises at least one curing agent, preferably surface-deactivated isocyanate, in addition to the polyurethane. Alternatively, the curing agent may comprise any other suitable substances, such as for example all aromatic isocyanates and/or aliphatic isocyanates. The curing agent may be embodied separately to the polyurethane or be integrated into the polyurethane. Furthermore, the reactive adhesive may comprise any further additives or be devoid of additives. This way, the asymmetric bonding means can be used for the bonding of textile components to be bonded on non-textile components to be bonded and may be used in a variety of fields of application, such as for example the field of medicine and the automobile industry.

It could be imagined that the reactive adhesive can be cured via radiation, in particular UV-radiation, or via the addition of a further substance. In order to simplify a manufacturing of the asymmetric adhesive means, it is proposed that the reactive adhesive can be cured via heat. Preferably, a curing temperature of the reactive adhesive is at least 80° C., especially preferably at least 90° C. This way, the melting of the thermoplastic adhesive and the curing of the reactive adhesive can be initiated in a single step. Advantageously, additional steps such as an irradiation of the reactive adhesive, which would require complex and expensive devices, may be omitted.

It could be imagined that the reactive adhesive is in a liquid or highly viscous state during a non-cured state regardless of a temperature and only exhibits a solid state after the curing. In order to further simplify the manufacturing of the asymmetric bonding means, it is proposed that the reactive adhesive is embodied as a latent reactive adhesive and exhibits thermoplastic properties in a non-cured state. A “latent reactive” adhesive is to be understood as an adhesive able to be stored in a non-cured state and to be cured without the addition of further substances. The reactive adhesive exhibiting “thermoplastic properties” in the non-cured state is to be understood as the adhesive having a melting point in the non-cured state defining a reversible transition between a liquid or highly viscous state and a solid state of the reactive adhesive. An adhesive exhibiting thermoplastic properties and a thermoplastic adhesive differ in particular in that the adhesive only exhibits thermoplastic properties in specific states, while the reversible transition of the thermoplastic adhesive is independent of a state of the thermoplastic adhesive. Preferably, the reactive adhesive has a curing temperature in the non-cured state which is above its melting point. The curing temperature in particular defines an irreversible transition between a non-cured state and a cured state of the adhesive. Preferably, the reactive adhesive cannot be transitioned from the solid state into the liquid or highly viscous state once it transitioned into the cured state. In particular, the melting point of the reactive adhesive is at least 35° C. This way, the reactive adhesive as well as the thermoplastic adhesive may be stored in their solid states and only melted during processing.

It could be imagined that the melting point of the reactive adhesive in the non-cured state is roughly identical to the curing temperature of the reactive adhesive. In order to further simplify the manufacturing of the asymmetric adhesive means, it is proposed that the melting point of the reactive adhesive in the non-cured state is at least 20° C., advantageously at least 30° C. lower than the curing temperature of the reactive adhesive. This way, an inadvertent initiation of the curing reaction of the reactive adhesive during a melting of the reactive adhesive can be prevented. Advantageously, the reactive adhesive may be melted any number of times without curing it, which simplifies a manufacturing and/or application of the asymmetric bonding means.

Preferably, the melting point of the reactive adhesive is at least 35° C., especially preferably at least 45° C., and at most 70° C., especially preferably at most 60° C. This way, an arrangement of the asymmetric bonding means on the components to be bonded can be simplified. Advantageously, the asymmetric bonding means can be easily heated up until the surface of the first adhesive layer is melted, which makes an arrangement of the first adhesive layer on one of the components to be bonded much easier.

It is possible that the asymmetric bonding means is embodied as a double-sided adhesive tape and comprises a carrier arranged between the adhesive layers. Preferably, the second adhesive layer is arranged directly on the first adhesive layer. In particular, the asymmetric bonding means is embodied as an asymmetric adhesive film. Preferably, the asymmetric bonding means comprises a liner releasably arranged on one of the adhesive layers. In particular, the liner may be removed after an application of the adhesive layer not covered by the liner on one of the components to be bonded in order to uncover the other adhesive layer so it can be contacted by the other component to be bonded. The liner may comprise any materials known to a person of ordinary skill in the art of liners. For example, the liner may comprise a cellulose, a fabric and/or a plastic foil. Preferably, the liner comprises a siliconized material, in particular a siliconized cellulose. This way, the asymmetric bonding means may be provided in an easy and cost-effective way.

The present technology further relates to a method for manufacturing the asymmetric bonding means.

It is proposed that the reactive adhesive is coated onto a liner in a wet state, subsequently, the reactive adhesive is dried to form the first adhesive layer, and the thermoplastic adhesive is laminated onto the first adhesive layer to form the second adhesive layer. It is possible that the liner is embodied as a process liner and is removed before a manufacturing of the asymmetric bonding means is finished. Preferably, the liner is embodied as a release liner configured to be removed right before an application of the asymmetric bonding means. This way, the asymmetric bonding means can be provided in an easy and cost-efficient manner, wherein the asymmetric bonding means achieves an improved bonding of components to be bonded which were difficult to bond so far. Advantageously, the lamination of the second adhesive layer on the first adhesive layer right after the coating of the reactive adhesive allows to take advantage of the fact that the reactive adhesive has not fully transitioned into the solid state yet and therefore exhibits a tackiness which facilitates the lamination step.

In particular, the thermoplastic adhesive and the liner are embodied as webs and are preferably moved along a process line via a sequence of guide cylinders. Advantageously, the thermoplastic adhesive and the liner are unwound from a supply roll and the asymmetric bonding means is wound onto a product roll in form of a laminate after the lamination step. Preferably, the winding step is followed by at least one converting step. The converting step may comprise any number of cutting steps and/or die-cutting steps. Preferably, the converting step comprises a roll-winding step of the asymmetric bonding means. The roll-winding step preferably comprises at least one cutting step or die-cutting step in which the asymmetric bonding means is processed into a thin strip, and at least one winding process in which the strip is wound on a further product roll. The winding process advantageously comprises a reversal of the direction of winding, which is performed especially advantageously when the strip reaches the end of the supply roll, by which the strip is wound in a stack of layers. This way, the amount of material that can be supplied with a single product roll can be increased.

Advantageously, a corona treatment is performed on the thermoplastic adhesive before the lamination step. Advantageously, the thermoplastic adhesive is guided to a grounded guide cylinder, wherein at least one electrode is arranged at the guide cylinder in order to perform the corona treatment. This way, the manufacturing of the asymmetric bonding means can be further improved. Advantageously, a melting of the thermoplastic adhesive before the lamination step may be omitted.

Especially advantageously, the reactive adhesive is embodied as a latent reactive adhesive and a tackiness of the reactive adhesive that remains after the drying step is taken advantage of for the lamination step. Preferably, a processing temperature of the drying step is above the melting point of the reactive adhesive, thereby causing the reactive adhesive to exhibit tackiness for a limited time after the drying step. This way, the manufacturing of the asymmetric adhesive step may be further simplified. Advantageously, an additional step comprising a heating of the reactive adhesive before the lamination step may be omitted. Especially advantageously, a reduction of the robustness and duration of a bond provided by the asymmetric bonding means caused by the additional step can be prevented.

The asymmetric bonding means and the method are not limited by the disclosed applications and embodiments. In particular, the asymmetric bonding means and the method may differ from this disclosure in terms of a number of elements, components, units and steps in order to fulfil any of the disclosed functions.

### DESCRIPTION OF FIGURES

Additional aspects are disclosed in the following description of the figures. The figures show an exemplary embodiment of the present technology. The figures, descriptions and claims comprise a multitude of features in combination. However, one of ordinary skill in the art is also able view these features on their own and assemble them into further, sensible combinations.

FIG. 1A schematic depiction of an asymmetric bonding means according to the present technology in a cross-sectional view.

FIG. 2A schematic chart representing a method for manufacturing the asymmetric bonding means.

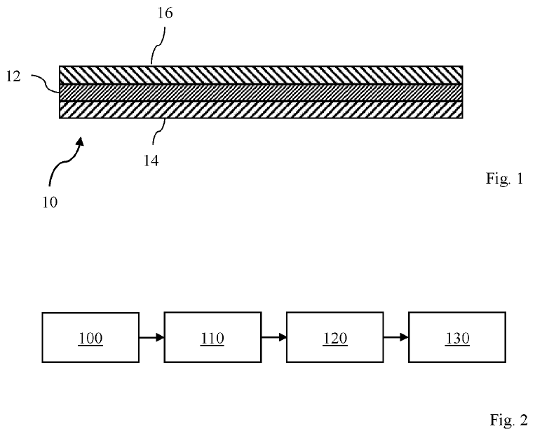

FIG. 1 shows an asymmetric bonding means 10. The asymmetric bonding means 10 provides a bonding of two different components to be bonded (not shown). One of the components to be bonded is embodied as a spring steel sheet. The other component to be bonded is embodied as a polyester fabric. Alternatively, the components to be bonded may comprise any other materials, structures and/or shapes, wherein the adhesives used in the asymmetric bonding means 10 will be changed if necessary.

The asymmetric bonding means 10 is embodied as an asymmetric adhesive film. The asymmetric bonding means 10 comprises a liner 16. The liner 16 is embodied as a release liner. Alternatively, the liner 16 may be embodied as a process liner. Furthermore, the asymmetric bonding means 10 may be embodied as a double-sided adhesive tape. In this case, the asymmetric bonding means 10 could comprise a carrier (not shown) instead of or in addition to the liner 16. The liner 16 comprises a siliconized paper. Alternatively, the liner 16 or the carrier could comprise a foam, a fabric, a fleece, any other types of cellulose and/or a plastic foil. The asymmetric bonding means 10 comprises a first adhesive layer 12. The liner 16 is arranged on a first main side of the first adhesive layer 12.

The first adhesive layer 12 comprises a reactive adhesive. The reactive adhesive comprises a polyurethane. Alternatively, the reactive adhesive may comprise any other suitable substances, such as for example epoxy resins, amines and/or amides. The polyurethane is embodied as an aliphatic polyurethane. Alternatively, the polyurethane could be embodied as any other types of polyurethane, such as for example an aromatic polyurethane. The reactive adhesive can be cured via heat. Alternatively, the reactive adhesive may be cured via irradiation or the addition of a further substance. A curing temperature of the reactive adhesive is roughly 100° C. The reactive adhesive is embodied as a latent reactive adhesive. A melting point of the reactive adhesive in a non-cured state is roughly 50° C.

The asymmetric bonding means 10 comprises a second adhesive layer 14. The second adhesive layer 14 is arranged opposite to the first adhesive layer 12. The second adhesive layer 14 is arranged directly on the first adhesive layer 12. The liner 16, the first adhesive layer 12 and the second adhesive layer 14 are arranged in a sandwich construction. The liner 16, the first adhesive layer 12 and the second adhesive layer 14 each have a thickness of roughly 50 μm. Depending on a field of application and the types of adhesives used, these thicknesses may be adjusted.

The second adhesive layer 14 comprises a thermoplastic adhesive. The thermoplastic adhesive comprises a copolyester elastomer. Alternatively, the second adhesive layer 14 could comprise any other suitable substances, such as for example polyamides, polyethylenes and/or polyalphaolefins. A melting point of the thermoplastic adhesive is roughly 120° C.

FIG. 2 shows a schematic chart representing a method for manufacturing the asymmetric bonding means 10. In a coating step 100, the reactive adhesive is coated on the liner 16 in a wet state. A blade is used for the coating of the reactive adhesive, however, it could also be imagined that other coating methods such as curtain coating could be used.

In a drying step 110, the liner 16 and the reactive adhesive are guided through a common drying channel. The processing temperature of the drying channel is roughly 60° C. After the drying step 110, the reactive adhesive forms the first adhesive layer 12 and is tacky. The drying step 110 is performed subsequently to the coating step 100.

In a treatment step 120, a corona treatment is performed on the thermoplastic adhesive. The thermoplastic adhesive is present as a non-adhesive foil. The thermoplastic adhesive is guided along a grounded guide cylinder, wherein a multitude of electrodes are arranged at the guide cylinder in order to perform the corona treatment. The treatment step 120 may be performed simultaneously or subsequently to the drying step 110.

In a lamination step 130, the thermoplastic adhesive is laminated on the first adhesive layer 12 to form the second adhesive layer 14. This step takes advantage of a transition of the first adhesive layer 12 into the solid state still being unfinished after the drying step 110. An additional step to melt the first adhesive layer 12 can be omitted, thereby reducing the amount of temperature swings the adhesive layers 12, 14 are exposed to and increasing their robustness. The lamination step 130 is performed subsequently to the treatment step 120.

### REFERENCE SIGNS

10 Asymmetric bonding means
12 First adhesive layer
14 Second adhesive layer
16 Liner
100 Coating step
110 Drying step
120 Treatment step
130 Lamination step

1. Asymmetric bonding means for bonding two different components to be bonded, with a first adhesive layer and a second adhesive layer arranged opposite to the first adhesive layer, characterized in that the first adhesive layer comprises at least one reactive adhesive and the second adhesive layer comprises at least one thermoplastic adhesive.

2. Asymmetric bonding means according to claim 1, characterized in that the thermoplastic adhesive comprises at least one copolyester elastomer.

3. Asymmetric bonding means according to claim 1 or 2, characterized in that a melting point of the thermoplastic adhesive is at least 90° C.

4. Asymmetric bonding means according to any of the preceding claims, characterized in that the reactive adhesive comprises at least one polyurethane.

5. Asymmetric bonding means according to any of the preceding claims, characterized in that the reactive adhesive can be cured via heat.

6. Asymmetric bonding means according to any of the preceding claims, characterized in that the reactive adhesive is embodied as a latent reactive adhesive, which exhibits thermoplastic properties in a non-cured state.

7. Asymmetric bonding means according to claims 5 and 6, characterized in that a melting point of the reactive adhesive in the non-cured state is at least 20° C. less than a curing temperature of the reactive adhesive.

8. Asymmetric bonding means according to claim 7, characterized in that the melting point of the reactive adhesive is at least 35° C. and at most 70° C.

9. Asymmetric bonding means according to any of the preceding claims, characterized in that the second adhesive layer is arranged directly on the first adhesive layer.

10. Method for manufacturing an asymmetric adhesive bonding means, in particular according to any of the preceding claims, characterized in that a reactive adhesive is coated onto a liner in a wet state, subsequently, the reactive adhesive is dried to form a first adhesive layer, and a thermoplastic adhesive is laminated onto the first adhesive layer to form a second adhesive layer.

11. Method according to claim 10, characterized in that a corona treatment is performed on the thermoplastic adhesive before the lamination step.

12. Method according to claim 10 or 11, characterized in that the reactive adhesive is embodied as a latently reactive adhesive and a tackiness of the reactive adhesive that remains after the drying step is taken advantage of for the lamination step.
